(19) United States
(12) Patent Application Publication
(10) Pub. No.: US 2020/0230892 A1
(43) Pub. Date: Jul. 23, 2020

(54) APPLICATOR FOR THERMALLY ACTIVATING A FUNCTIONAL LAYER OF A COATING MATERIAL

(71) Applicant: HOMAG GmbH, Schopfloch (DE)

(72) Inventor: Felix SCHULZ, Aalen (DE)

(21) Appl. No.: 16/639,093

(22) PCT Filed: Aug. 14, 2018
(86) PCT No.: PCT/EP2018/071997

§ 371 Date: Feb. 13, 2020

(30) Foreign Application Priority Data
Aug. 16, 2017 (DE) 10 2017 118 660.3

(51) Int. Cl. B29C 65/48; B29C 65/52

(52) U.S. Cl. CPC B29C 65/4845; B29C 65/52

(57) ABSTRACT

The present invention provides an applicator for thermally activating a functional layer of a coating material, comprising: a base body designed to guide the coating material in a running direction, wherein the base body is able to guide electromagnetic waves in the direction of the guided coating material, wherein a dielectric is arranged inside the base body and the dielectric is formed of granular material. The present invention also provides a device for thermally activating a coating material, a use of a dielectric, and a method for thermally activating a functional layer of a coating material.

### SUBJECT MATTER OF THE INVENTION

The present invention relates to an applicator for thermally activating a functional layer of a coating material. Moreover, the present invention relates to a device for thermally activating the functional layer of the coating material, a use of a dielectric, and a method for thermally activating a functional layer of a coating material.

### PRIOR ART

Coating cut surfaces of plate-shaped workpieces, so-called workpiece narrow surfaces, with an approximately strip-like coating material has proved to be successful. On the one hand, the cut surfaces can thereby be adapted to the properties of the surface of the workpiece without the need for costly finishing. On the other hand, with such a coating it is possible to design the core of the workpiece with a different material, such as one that is less expensive, from that of the surfaces visible from the outside.

In order to bond the workpiece with the coating material, an adhesive or a glue is used. In particular, an adhesive is used which is activated by an energy input and only then can a resilient bond be formed between two components (the coating material and the workpiece).

There are numerous ways of integrating this adhesive into the joining process. For instance, EP 1 163 864 B1 proposes a method in which a plastics edge is coextruded with an adhesive layer. This composite of coating material and activatable functional layer (or adhesive layer) is subsequently fused when applied to the workpiece by using laser light in the region of the adhesive and is pressed onto the workpiece.

The thermal activation of the functional layer by means of electromagnetic waves, in particular in the microwave spectrum, is also already known. The use of electromagnetic waves in the microwave spectrum can have advantages in terms of accuracy and the adaptability of the input of energy into the functional layer. In this case the activation of the functional layer inside an applicator has proven to be advantageous.

However, the use of electromagnetic waves for activating the functional layer of coating materials presents challenges since in order to ensure as high as possible an energy input into the coating material, the applicator must be a certain size. In view of the space constraints of aggregates, this cannot always be realized without problems.

An applicator as shown in FIG. 1, for example, is already known. The applicator 1 serves to thermally activate in the base body 3 thereof a functional layer of the coating material 8, which happens by way of electromagnetic waves 5. In order to effectively facilitate this thermal activation, the following two marginal conditions must be taken into consideration. First, there should be a wave maximum of the standing electromagnetic wave 5 as precisely as possible in the direction of propagation at the level of the coating material 8. In this way, it is possible for the maximum dissipation of electromagnetic energy into thermal energy to take place in the functional layer. Furthermore, a subsequent reflection of the electromagnetic waves should take place approximately at a zero-crossing of the electromagnetic waves. Thus, positive interference can take place at the functional layer itself, which in turn facilitates an effective coating of the functional layer. This can be seen in FIG. 1, in which both marginal conditions are met.

On account of these marginal conditions, there are restrictions in terms of the size of the base body 3 of the applicator 1.

A known solution to this problem is to fill at least one part of a cavity 3 of the applicator 1 with a dielectric.

The propagation speed of a wave is therefore given by

$$c = \frac{1}{\sqrt{μ ɛ}} ,$$

where c is the propagation speed, μ is the permeability and E is the permittivity. In the case of dielectrics, the permeability μ is approximately equal to 1, while the permittivity E is greater than 1 and differs depending on the dielectric. In the hypothetical case that the entire interior of the applicator 1 were filled with, for example, aluminum oxide with a permittivity E=9.5, the result would therefore be that the applicator only needs approximately 32% of the size of the unfilled applicator:

$$\frac{1}{\sqrt{9 \text{,} 5}} \approx 32 \% .$$

Accordingly, the use of aluminum oxide as a dielectric, as a result of which a considerable saving in terms of size can be facilitated, is already known. To adapt this material, sintered blocks of the material can be fitted into the base body 3. Such sintered blocks of aluminum oxide are specifically adapted for a certain applicator, wherein complex geometries result in high production costs. Moreover, aluminum oxide in a sintered state is hard and brittle, and therefore finishing is only possible to a limited extent, if at all. If during the sintering process impurities are introduced into the hollow material through the binder, for example, the resulting aluminum oxide cannot be used at high electrical field strengths, which may occur, however, during the thermal activation of coating material by means of electromagnetic waves. The use of other dielectrics, such as PTFE or Teflon, with easier processing options is still not necessarily expedient, since the permittivity thereof is not high enough, and the processing of these dielectrics in a solid state is not sufficiently easier. Thus, the sintering of specially formed ceramic powders remains, which can take place by way of isostatic pressing, for example.

### DESCRIPTION OF THE INVENTION

Based on the above, the object of the present invention is to provide an applicator for thermally activating a functional layer of a coating material, which has lower production costs but which nevertheless facilitates a high permittivity and can easily be molded into a complex shape.

As a solution, the present invention provides the applicator according to claim 1.

The invention is based on the finding that the aforementioned problems have arisen primarily because the high production costs of dielectrics consisting of aluminum oxide is above all the result of the fact that the sintering process of ceramic in a specific geometry is costly and also leads to a brittle product. Moreover, it may be necessary to subject the sintered body to finishing, for example, which is another costly process. The invention is also based on the finding that the technical effect of sintering is primarily due to the fact that mechanical properties of the ceramic are considerably improved by a granulate becoming a solid, while the permittivity of the ceramic is only slightly improved.

In view of these findings, the present invention provides an applicator for thermally activating a functional layer of a coating material. The applicator comprises a base body which is designed to guide the coating material in a running direction, wherein the base body is able to guide electromagnetic waves, in particular microwaves, in the direction of the guided coating material, wherein a dielectric is arranged inside the base body and the dielectric is formed at least in part of granular material.

A granular dielectric can easily be molded into any possible shape. Furthermore, a material which is granular is not brittle. A granulate is to be understood here to be an accumulation of solid particles which are small relative to the size of the applicator, such that a defined space in the applicator can be filled with the moldable granulate. Examples of granulates include powders having a grain size of between 1 and 100 μm. In one possible embodiment, the granular dielectric can be dispersed in a pasty mass or a liquid, for example.

As a consequence of providing a moldable granular dielectric, it is possible to avoid the high production costs arising as a result of sintering and yet nevertheless maintain a high permittivity of the dielectric, which can also easily be molded into a complex shape. Thus, the complexity of production can be reduced.

Preferably, the dielectric is arranged in the applicator described above in such a way that the electromagnetic waves are guided through the dielectric in the direction of the coating material.

When the electromagnetic waves pass through the dielectric, the propagation speed thereof increases depending on the permittivity of the dielectric. Thus, the dimensions of the applicator can be reduced, as already mentioned above.

Preferably, the dielectric comprises ceramic and/or glass, more preferably aluminum oxide (AL₂O₃) and/or quartz glass (SiO₂).

These substances have proved to be particularly suitable dielectrics owing to the high permittivity and low dielectric loss factor thereof.

More preferably, the applicator is designed to be connected to a conductive means for electromagnetic waves, through which the electromagnetic waves are fed into the applicator.

The applicator can therefore receive electromagnetic waves through the conductive means for electromagnetic waves, for example in the form of a waveguide or in the form of a coaxial conductor. These waves can be generated by means of a generator.

Further preferably, the base body guides the coating material in such a way that the inside of the base body is sealed off from the coating material, in particular by way of a solid portion of the dielectric and/or by guidance of the coating material in the applicator.

During the thermal activation of the functional layer of the coating material, gas escapes from the coating material. Thus, sealing the inside of the base body can prevent gas release and can therefore prevent impurities from reaching the inside of the base body and in particular the granular dielectric.

The dielectric preferably has a dielectric loss factor of less than 5×10⁻³ and more preferably of less than 5×10⁻⁴ and/or a permittivity of greater than 1.5, preferably greater than 2, more preferably greater than 3 and even more preferably greater than 8. With this loss factor, so little power of the electromagnetic waves is dissipated into heat that there is no need to provide a cooling system for the applicator. Moreover, this facilitates an efficient transmission of energy by means of the electromagnetic waves. A permittivity greater than 1.5, preferably greater than 2, more preferably greater than 3 and even more preferably greater than 8 facilitates a reduction of the space of the applicator, depending in particular on the degree of filling.

Furthermore, the present invention provides a device for thermally activating a coating material. This device comprises a generator for generating electromagnetic waves, in particular microwaves, and an applicator as described above, which is able to apply the electromagnetic waves generated in the generator to the coating material.

The present invention is also concerned with the use of a dielectric in an applicator for thermally activating coating material by means of electromagnetic waves, in particular microwaves, wherein the dielectric in the base body is formed at least in part of granular material.

Preferably, the applicator is an applicator as described above.

An additional aspect of the present invention is a method for producing an applicator for thermally activating a functional layer of a coating material, comprising the following steps: providing a base body, and introducing a moldable dielectric into the base body.

This method can preferably be used to produce an applicator as described above. The moldable dielectric is to be understood to be, for example, the granular dielectric as described above, but the use of a pasty dielectric is also possible, or a granular dielectric dispersed in a pasty or liquid carrier material. A moldable dielectric can take a variable form, such as the form of the interior of the applicator in which the moldable dielectric is provided.

Preferably, the method comprises the additional step of introducing a solid dielectric into the base body for fixing the moldable dielectric therein.

With regard to the advantages of the use of the dielectric and of the method, reference is made to the advantages of the applicator itself. It is understood that all of the preferred embodiments, features and functions of the applicator, the device, the use and the method can be combined.

### BRIEF DESCRIPTION OF THE DRAWINGS

FIG. 1 shows a sectional view of an example of an applicator as according to the prior art.

FIG. 2 shows a sectional view of a preferred embodiment of an applicator as according to the invention.

### PREFERRED EMBODIMENTS OF THE PRESENT INVENTION

FIG. 2 shows a preferred embodiment of an applicator as according to the invention. The applicator 10 is intended to be connected to a generator (not shown) which generates electromagnetic waves. It is also intended that these electromagnetic waves thermally activate a functional layer of a coating material 8.

In this preferred embodiment, the electromagnetic waves are, in particular, microwaves in a frequency band of between 2.4 GHz and 2.5 GHz, but the frequency band of 5.725 GHz to 5.875 GHz is also conceivable here. This is provided as the ISM band (industrial, scientific and medical band) in the Radio Regulations of the Constitution and Convention of the International Telecommunications Union, an international treaty on the use of radio frequencies, and therefore also for such applications.

The applicator 10 firstly comprises a base body 13, which forms the structure of the applicator 10 and receives further elements thereof. Electromagnetic waves are received in the applicator via a conductive means (not shown) for electromagnetic waves and they are transferred therethrough to the coating material 8. The applicator 10 therefore serves as a resonator for electromagnetic waves. Waveguides and coaxial conductors can be used as conductive means for electromagnetic waves, wherein a waveguide usually refers to a metal pipe having a substantially rectangular, circular or elliptical cross-section and a coaxial conductor normally refers to a flexible conductor. In FIG. 2 the direction of propagation of the electromagnetic waves can be seen to be orthogonal to a feed direction of the coating material 8. The feed direction of the coating material 8 is in the cutting direction of FIG. 2. Furthermore, for guiding the coating material a seal can be provided, which encloses the coating material 8 and therefore seals off the inside of the applicator 10. In particular, there is therefore no direct transition between a region through which the coating material 8 runs and between other cavities of the applicator 10. Thus, when using the applicator 10 no impurities can reach these inner regions, which would entail lengthy and costly cleaning processes.

In the embodiment according to the invention as described herein, a part of the applicator is filled with a dielectric 14. As a consequence, the dimensions of the applicator can be reduced by a factor depending on the dielectric used. The dielectric 14 is formed at least in part of granular material. A core of the dielectric 14 consists of aluminum oxide powder (AL₂O₃). Sintered aluminum oxide has a permittivity of approximately 9.5, which is very high compared with other dielectrics such as Teflon (2.0), for example, or quartz glass (3.75). Non-sintered aluminum oxide, i.e. the aluminum oxide powder used in the embodiment shown herein, has a slightly lower permittivity. This depends primarily on the remaining amount of air in the aluminum oxide powder.

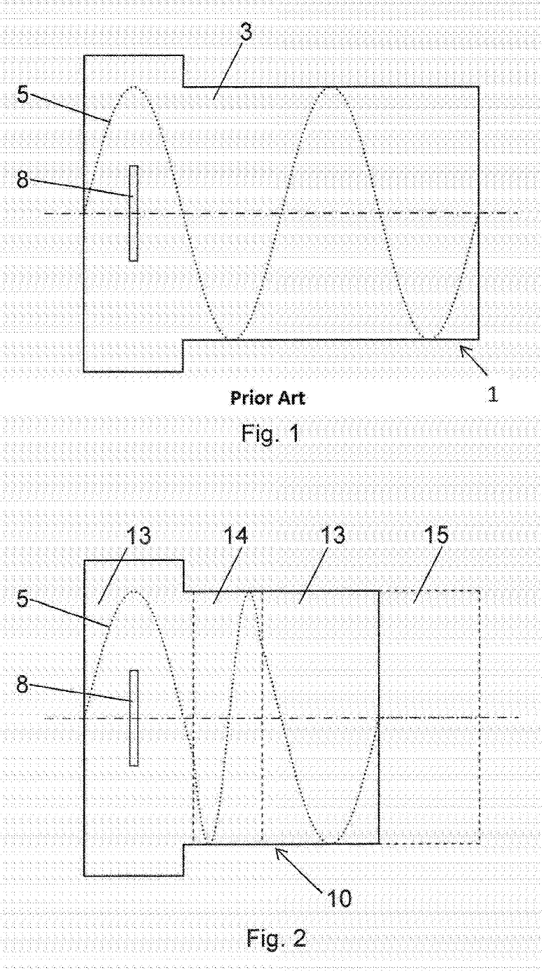

With the use of the dielectric 14, the size of the applicator 10 can therefore be reduced, which is illustrated in FIG. 2 with the dashed line 15. This line 15 relates to the applicator volume without the use of a dielectric, as shown for example in FIG. 1.

An alternative embodiment also provides for the use of quartz glass powder (SiO₂) as the dielectric. As mentioned above, this has a slightly lower permittivity and can therefore be used when the reduction of the volume of space of the applicator is not a particularly high priority.

In the embodiment shown herein, the aluminum oxide powder is spatially fixed by means of quartz glass in solid form. For manufacture purposes, a first quartz glass cover, for example, can therefore first of all be used in the applicator 10. This is shown in FIG. 2 to the left of the dielectric 14 along the dashed line. This separates the internal cavity of the applicator into two parts. In a subsequent step, a granular dielectric is introduced into the open cavity on the right of the applicator. The granular dielectric can then be pressed using a die, for example, in order to reduce the air content in the granular dielectric. Subsequently, a second quartz glass cover can be used, which is located along the dashed line to the right of the dielectric 14. Thus, the granular dielectric is fixed between two quartz glass covers and can ensure the desired propagation of the electromagnetic waves 5.

In alternative embodiments, it is not absolutely essential to provide a granular dielectric between two covers of a solid dielectric. If, for example, a dielectric is provided to the left of the edge band 8 in the applicator 10 of FIG. 2, this can also be arranged on the left-hand edge of the applicator 10. Thus, the granular dielectric can be fixed by only one layer of solid dielectric.

1. An applicator (10) for thermally activating a functional layer of a coating material (8), comprising:
a base body (13) designed to guide the coating material (8) in a running direction,
wherein the base body (13) is able to guide electromagnetic waves (5), in particular microwaves, in the direction of the guided coating material (8),
wherein a dielectric (14) is arranged inside the base body (13), and
the dielectric (14) is formed at least in part of granular material.

2. The applicator (10) according to claim 1,
wherein the dielectric (14) is arranged in such a way that the electromagnetic waves are guided through the dielectric (14) in the direction of the coating material (8).

3. The applicator (10) according to claim 1 or claim 2,
wherein the dielectric (14) comprises ceramic and/or glass, preferably aluminum oxide (AL₂O₃) and/or quartz glass (SiO₂).

4. The applicator (10) according to one of claims 1 to 3,
wherein the applicator (10) is designed to be connected to a conductive means for electromagnetic waves, which is preferably configured in the form of a waveguide or a coaxial conductor, through which the electromagnetic waves (5) are fed into the applicator (10).

5. The applicator (10) according to one of claims 1 to 4,
wherein the base body (13) guides the coating material (8) in such a way that the inside of the base body (13) is sealed off from the coating material (8), in particular by way of a solid portion of the dielectric and/or by guidance of the coating material in the applicator.

6. The applicator (10) according to one of claims 1 to 5,
wherein the dielectric (14) has a dielectric loss factor of less than 5×10⁻³ and preferably of less than 5×10⁻⁴ and/or a permittivity greater than 1.5, preferably greater than 2, more preferably greater than 3 and even more preferably greater than 8.

7. The applicator (10) according to one of claims 1 to 6,
wherein the granular dielectric is fixed by means of a dielectric which is not granular.

8. A device for thermally activating a coating material (8), comprising:
a generator for generating electromagnetic waves (5), in particular microwaves, and
an applicator (10) according to one of claims 1 to 6, which is able to apply the electromagnetic waves (5) generated in the generator to the coating material (8).

9. A use of a dielectric (14) in an applicator (10) for thermally activating a coating material (8) by means of electromagnetic waves (8), in particular microwaves,
wherein the dielectric (14) is formed at least in part of granular material.

10. The use of a dielectric (14) according to claim 9,
wherein the applicator (10) is an applicator according to one of claims 1 to 6.

11. A method for producing an applicator (10) for thermally activating a functional layer of a coating material (8) preferably according to one of claims 1 to 7, comprising the following steps:
providing a base body (10),
introducing a moldable, preferably granular, dielectric into the base body (10).

12. The method according to claim 11, comprising the following additional step:
introducing a solid dielectric into the base body (10) for fixing the moldable dielectric therein.
